(19) United States
(12) Patent Application Publication
(10) Pub. No.: US 2008/0258424 A1
(43) Pub. Date: Oct. 23, 2008

(54) Unitary vehicular front end and method of use thereof

(76) Inventor: John Paul, McDonough, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/787,787

(22) Filed: Apr. 18, 2007

(51) Int. Cl. B62K 21/18

(52) U.S. Cl. 280/276; 280/279; 280/762

(57) ABSTRACT

A unitary vehicular front end is provided comprising a left and right side, each having a handle section with a fork segment thereof, the left and right sides being bridged together via a connecting member having a central bar for receiving the frame of a vehicle, such as a motorcycle or other two or three-wheeled vehicle. A method of securing the unitary vehicular front end to the frame of a vehicle is also provided.

### FIELD OF INVENTION

The present invention relates to a front end of a transportation device which uses handle bars and a fork segment for securing a wheel, such as a two-wheeled vehicle, three-wheeled vehicle, or the like.

### BACKGROUND ART

There are various types of front end assemblies for transportation devices which use handle bars. Many such devices disclose triple tree assemblies which are well known in practice. Some devices disclose multiple types of suspensions or stabilizers for front end assemblies.

One such device discloses a front end assembly that provides the illusion that the front fork tubes continue upward through the triple tree to form the handlebars. However, this is just an illusion does not teach a unitary piece comprising both handle bars and fork members.

A triple tree assembly, while popular, interrupts the smooth flow of the front end. With the popularity of custom motorcycles rising, many riders desire an aesthetically pleasing smooth flowing front end. Further, triple tree assemblies are expensive to manufacture and repair. Alterations in a triple tree can also be difficult, costly, and time consuming. The removal and replacement of a front end for a vehicle, such as a motorcycle, can be extremely complicated and time consuming.

Further, because previously-known devices comprise multiple components secured together via fasteners, there is a risk of unintentional disassembly during use, causing risk of injury or death of the rider and/or passenger.

Therefore, it is readily apparent that there is a need for a unitary vehicular front end which is more cost efficient in production and repair, provides an aesthetically pleasing design, and allows for the easy removal of the front end from the vehicle frame such as for replacement and/or service of the front end or frame.

### BRIEF SUMMARY OF THE INVENTION

Briefly described, in a preferred embodiment, the present invention overcomes the above-mentioned disadvantages and meets the recognized need for such a device by providing a unitary vehicular front end comprising a left handle bar section, a right handle bar section, a left fork segment, and a right fork segment. The left handle bar section and the left fork segment meet forming one continuous line comprising the left side. The right handle bar section and the right fork segment meet forming one continuous line comprising the right side. A connecting member which bridges the left and right sides together is disposed proximate the meeting of the handle bar sections and the fork segments, thus forming a single, unitary piece for a front end of a vehicle, such as a two-wheeled or three-wheeled vehicle. The single unitary piece as formed does not require assembly of its structural handlebar, for and connecting members.

Such a unitary front end for a vehicle reduces the cost and is more aesthetically pleasing than other devices currently extant in the art. Further, no adjustments or alterations are needed once it is installed. This reduces manufacturing, repair, and replacement costs, as well as, the amount of time spent working on the transportation vehicle.

Further, the unitary vehicular front end also includes a central bar extending substantially perpendicular from the connecting member. This central bar may be used to receive the frame of a motorcycle or another type of two-wheeled or three-wheeled vehicle. The frame may be secured to the unitary vehicular front end by any known methods, but particularly a nut may be screwed on to a threaded portion of the central bar to secure the frame around the central bar. This configuration allows for the unitary vehicular front end to be attached to the frame of a vehicle by the central bar, wherein the central bar comprises a threaded portion, and wherein a nut is secured to the threaded portion of the central bar. Thus, should the unitary front end need to be removed from the frame, time is saved by removal of the single nut. Further, another unitary vehicular frame, or alternately a unitary front end, could be secured in rapid fashion to a different front end or frame, respectively, saving time and money and allowing for a greater flexibility in modifying the vehicle depending on terrain or circumstances.

The unitary vehicular front end may also have apertures on the handle bar sections to provide an attachment point for one or more mirrors. An attachment bar may also bridge the left and right sides, wherein the attachment bar has an aperture to receive at least one head light assembly. The attachment bar may preferably also provide apertures for connecting turning lights. Providing mirrors and lights increases the safety of the vehicle. Shock absorption may be provided by a shock and rocker system as known in the art, thus providing a higher level of comfort to the user.

The unitary front end for a vehicle, such as, for exemplary purposes only, a motorcycle or the like, allows for more cost efficient construction and repair, easier assembly, and a more aesthetically pleasing design. Further, the unitary vehicular front end can be easily removed more quickly for replacement, repairs, or changes in circumstances, thus saving time and money.

According to its major aspects and broadly stated, the present invention in its preferred form is a unitary front end for a vehicle, comprising left and right sides formed by a handle bar section and a fork segment, wherein the left and right sides are connected via a connecting member disposed at approximately the midpoint of the sides. It will be recognized by those skilled in the art that the connecting member could be disposed higher or lower than the approximate midpoint of the unitary front end.

In a preferred embodiment, the unitary vehicular front end comprises left handle bar section having a left fork segment extending from said left handle bar section, a right handle bar section having a right fork segment extending from said right handle bar section, a connecting member disposed between and connecting said left handle bar section and said right handle bar section, wherein said left handle bar section, said right handle bar section, said left fork section, said right fork section, and said connecting member comprise a single steering mechanism.

In a further embodiment, the unitary vehicular front end may further comprise a central bar for receiving a transportation device frame, wherein the transportation device frame is in pivotal communication with said connecting member.

More specifically, the present invention in a preferred embodiment comprises a unitary front end for a vehicle, such as a two or three-wheeled vehicle. The unitary vehicular front end preferably has both a left side and a right side, wherein the left side comprises a left handle bar section which flows into a left fork segment preferably meeting proximate a juncture where both the left handle bar section and the left fork segment preferably meet a connecting member, and wherein the right side comprises a right handle bar section which flows into a right fork segment preferably meeting proximate a juncture where both the right handle bar section and the right fork segment preferably meet the connecting member, thereby forming the unitary vehicular front end.

The connecting member also preferably comprises a central bar at an enforcement point. The transportation vehicle preferably comprises a frame, wherein the frame preferably comprises a securing member, and wherein the securing member is preferably adapted to receive the central bar of the unitary vehicular front end therewithin, and wherein installation of a nut preferably secures the securing member of the frame upon the central bar, thereby removably attaching the unitary vehicular front end to the frame of the transportation vehicle. Thus, the unitary vehicular front end may be readily removed by unfastening the nut from the threaded portion of the central bar and sliding the securing member of the frame off of the central bar, thereby saving both time and money.

The unitary vehicular front end also preferably comprises a light receiving bar having an aperture to receive at least one light assembly, a single headlight assembly containing multiple lights, or multiple light assemblies containing at least one light each.

Additionally, the unitary vehicular front end may preferably comprise shock absorbers having an upper bushing, a lower bushing, and a body with a spring disposed thereon. The shock absorbers are preferably disposed on the fork segment, wherein the upper bushings of the shock absorbers are preferably secured to the fork segment at upper apertures, and wherein the shock absorbers and a upper apertures are preferably adapted to receive a bolt, although other means of attaching the shock absorber to the unitary vehicular front end are contemplated and understood to exist in the art, thus providing a shock absorbing system which dampens the effects of traveling in or upon the transportation vehicle.

Additionally, the unitary vehicular front end may also preferably comprise a left and right rocker, each preferably having a first end, a middle, a second end, and a curved member, wherein the first ends are preferably adapted to be secured to an axle of a wheel and the second ends are preferably secured to the lower fork segments through the fork segment lower apertures, and wherein the middles of the rockers are preferably adapted to receive a bolt. The lower bushings of the shock absorbers are preferably adapted to receive the bolt, thus the lower bushings of the shock absorbers and the middle of the rockers may preferably be connecting by the bolt. The curved members of the rockers are preferably secured at one end to the axle, and at the other end to the second ends of the rockers. Thus the shock absorber/rocker combination is formed on both the left and right side, providing cushioning of the ride of the transportation vehicle.

The unitary vehicular front end may alternatively be removably secured to the frame of the transportation vehicle via a universal joint, wherein the universal joint is preferably secured to the frame via a securing member and secured to the unitary vehicular front end via the central bar or other suitable connecting member.

In use, the unitary vehicular front end is preferably secured to the frame, thereby comprising a transportation vehicle. Should necessity arise, the unitary vehicular front end may be removed from the frame by removing the nut and sliding the securing member of the frame off of the central bar of the connecting member. To reassemble the transportation vehicle, the securing member of the frame is once again disposed on the central bar of the connecting member and secured to the unitary vehicular front end via a nut. Thus, a quick and efficient method to remove and replace a front end of a motorcycle is provided for, thereby reducing time, saving money, and increasing efficiency.

Accordingly, a feature and advantage of the present invention is its ability to provide a front end for a vehicle which is more cost efficient to manufacture, produce, and replace.

Another feature and advantage of the present invention is its ability to provide a front end for a vehicle which is unitary, thereby reducing the complications which result from having multiple pieces, including the number of necessary repairs and the amount of labor necessary for repairs.

Yet another feature and advantage of the present invention is the unitary structure of the front end for a vehicle which allows it to be removed from a vehicle by removing a single nut.

Still another feature and advantage of the present invention is its ability to provide a vehicular front end which is more aesthetically pleasing.

Yet still another feature and advantage of the present invention is that it is unitary and thus does not require assembly of its structural components, thus overcoming the hazard of multiple fastened components hazardously becoming loose or apart during travel.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to the elements throughout, and in which:

FIG. 1 shows a perspective view of a preferred embodiment with a motorcycle frame secured thereupon;

FIG. 2 shows an elevated front view of the preferred embodiment; and

FIG. 3 shows an elevated side view of the preferred embodiment.

### DETAILED DESCRIPTION OF THE PREFERRED AND SELECTED ALTERNATE EMBODIMENTS

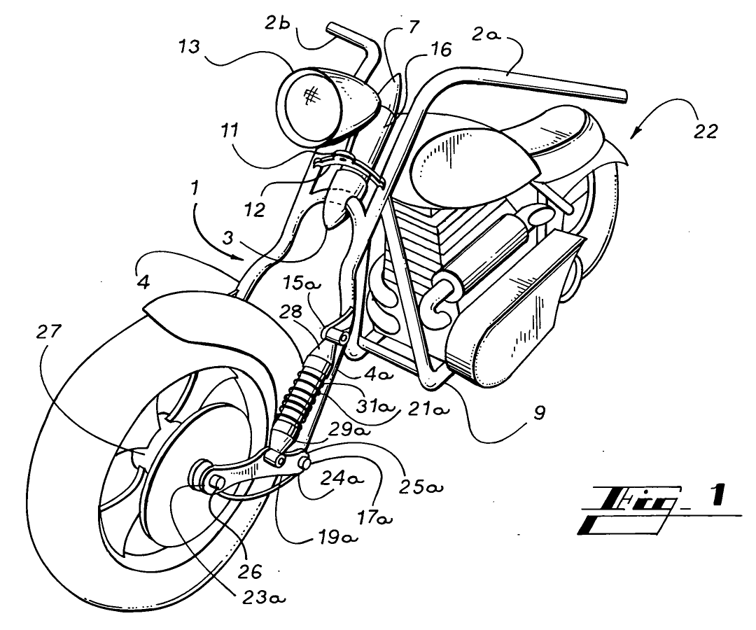

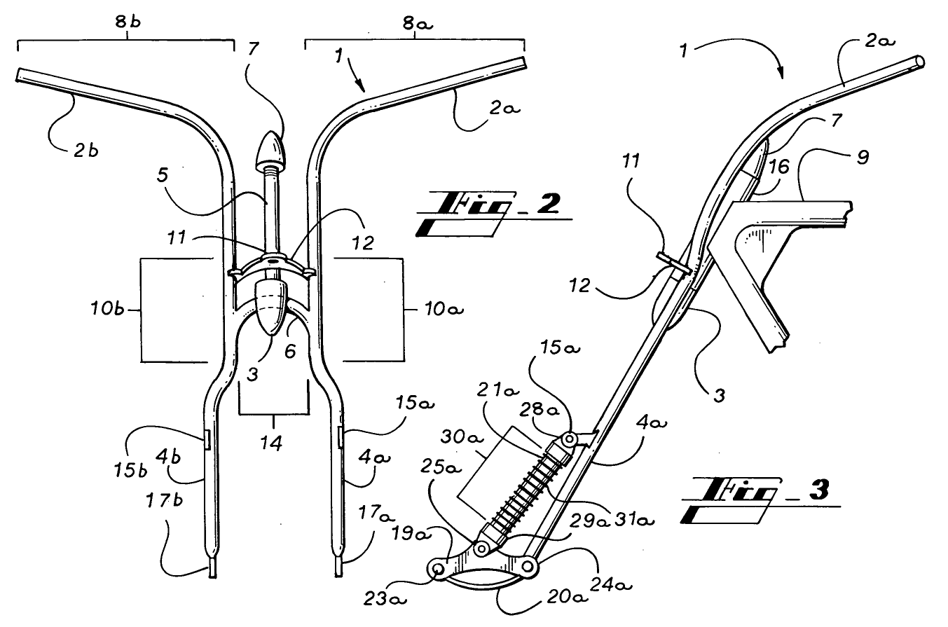

In describing the preferred and selected alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in a preferred embodiment comprises unitary vehicular front end 1 for vehicle 22, such as illustrated motorcycle. Unitary vehicular front end 1 preferably comprises both left side 8a and right side 8b, wherein left side 8a comprises left handle bar section 2a which flows into left fork segment 4a, preferably meeting proximate juncture 10a, and wherein both left handle bar section 2a and left fork segment 4a preferably meet connecting member 6. Right side 8b comprises right handle bar section 2b which flows into right fork segment 4b, preferably meeting proximate juncture 10b, wherein both right handle bar section 2b and right fork segment 4b preferably meet connecting member 6, thereby forming unitary vehicular front end 1.

In another preferred embodiment, connecting member 6 preferably selectively connects to central bar 5 at enforcement point 3. Transportation vehicle 22 preferably comprises frame 9, wherein frame 9 preferably comprises securing member 16, and wherein securing member 16 is preferably adapted to receive central bar 5 of unitary vehicular front end 1 therewithin, and wherein installation of nut 7 preferably secures securing member 16 of frame 9 upon central bar 5, thereby removably attaching unitary vehicular front end 1 to frame 9 of transportation vehicle 22. Thus, unitary vehicular front end 1 may be readily removed by unfastening nut 7 and sliding securing member 16 of frame 9 off of central bar 5.

In yet another preferred embodiment unitary vehicular front end 1 may comprise light receiving bar 12 having aperture 11 to receive headlight assembly 13. Further, light receiving bar 12 may preferably be secured to both the left side 8a and the right side 8b of the unitary vehicular front end 1. The light receiving bar may be positioned to receive a headlight assembly 13 or preferably at least one turn signal light assembly (not shown).

In still another preferred embodiment, unitary vehicular front end 1 may preferably comprise left shock absorber 21a preferably comprising left upper bushing 28a, left lower bushing 29a, and left body 30a with left spring 31a thereon. Left shock absorber 21a is preferably disposed at left fork segment 4a, wherein left upper bushing 29a of left shock absorber 21a is preferably secured to left fork segment 4a at left fork segment upper aperture 15a via a suitable fastener as such is known in the art. The unitary vehicular front end 1 preferably also comprises right shock absorber 21b (not shown), preferably comprising right upper bushing 28b (not shown), right lower bushing 29b (not shown), right body 30b (not shown), and right spring 31b (not shown) thereon. Right shock absorber 21b is preferably disposed at right fork segment 4b where right upper bushing 29b of right shock absorber 21b is preferably secured to right fork segment 4b at right fork segment upper aperture 15b via a fastener. Thus a shock absorption system is provided for both left and right sides, 8a, 8b, thereby dampening the effects of traveling in transportation vehicle 22.

In another preferred embodiment, left rocker 19a and right rocker 19b (not shown) preferably comprise first ends 23, middles 25, second ends 24, and curved members 20, wherein first ends 23 are preferably adapted to be secured to axle 26 of wheel 27 and second ends 24 are preferably secured to lower fork segments 4a, 4b, through fork segment lower apertures 17a, 17b and wherein middles 25 of rockers 19 preferably connect to lower bushings 29 of shock absorbers 21 via bolt. Curved members 20 of rockers 19 are preferably secured at one end thereof to axle 26 and at the other end to lower apertures 17. Thus shock absorber 21/rocker 19 combination provides cushioning of ride of transportation vehicle 22.

In an alternate embodiment, unitary vehicular front end 1 may be removably secured to frame 9 of transportation vehicle 22 via an alternate means, such as a universal joint (not shown), wherein the universal joint is preferably secured to frame 9 at securing member 16. Other means of removably connecting objects extant in the art are contemplated.

In use, unitary vehicular front end 1 is preferably secured to frame 9, thereby comprising transportation vehicle 22. Should necessity arise, unitary vehicular front end 1 may be removed from frame 9 by removing nut 7 and sliding securing member 16 of frame 9 off of central bar 5 of connecting member 6. To reassemble transportation vehicle 22, securing member 16 of frame 9 is once again disposed on central bar 5 of connecting member 6 and secured to unitary vehicular front end 1 via nut 7.

The foregoing description and drawings comprise illustrative embodiments of the present invention. Having thus described exemplary embodiments of the present invention, it should be noted by those skilled in the art that the embodiments within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A unitary vehicular front end comprising:
a left handle bar section having a left fork segment extending from said left handle bar section;
a right handle bar section having a right fork segment extending from said right handle bar section;
a connecting member disposed between and connecting said left handle bar section and said right handle bar section, wherein said left handle bar section, said right handle bar section, said left fork segment, said right fork segment and said connecting member form a unit comprising a single piece.

2. The unitary vehicular front end of claim 1, further comprising a central bar for receiving a frame of a transportation device, wherein said frame is in communication with said connecting member.

3. The unitary vehicular front end of claim 2, wherein said connecting member comprises a first side and a second side, wherein said connecting member joins said left handle bar section and said right handle bar section at substantially a juncture between said left handle bar section and said left fork segment on said first side of said connecting member and at substantially a juncture between said right handle bar section and said right fork segment on said second side of said connecting member.

4. The unitary vehicular front end of claim 2, wherein said transportation device is a motorcycle.

5. The unitary vehicular front end of claim 2, wherein said transportation device comprises a front wheel and at least one back wheel.

6. The unitary vehicular front end of claim 2, wherein said left fork segment comprises an aperture disposed on a lower portion of said left fork segment for receiving a left rocker, and wherein said right fork segment comprises an aperture disposed on a lower portion of said right fork segment for receiving a right rocker.

7. The unitary vehicular front end of claim 2, wherein said left fork segment comprises an aperture disposed on an left upper portion of said left fork segment, said right fork segment comprises an aperture disposed on an right upper portion of said right fork segment, and wherein said unitary vehicular front end further comprises a left shock absorber secured to said left fork segment at said left upper portion, and a right shock absorber secured to said right fork segment at said right upper portion.

8. The unitary vehicular front end of claim 2, further comprising at least one of said left handle bar section and said right handle bar section having an aperture for receiving a mirror.

9. The unitary vehicular front end of claim 2, wherein said central bar comprises threads for receiving a nut to secure said transportation device frame.

10. The unitary vehicular front end of claim 1, further comprising a light receiving bar having an aperture, wherein said light receiving bar is in communication with said left handle bar section and said right handle bar section, and wherein at least one light assembly is removably secured to said light receiving bar.

11. A unitary front fork and handle bar comprising:
a unitary steering mechanism for connecting a transportation device frame to a wheel.

12. The unitary front fork and handle bar of claim 11, further comprising a shock absorber and rocker system for attaching said unitary steering mechanism to said wheel.

13. The unitary front fork and handle bar of claim 11, further comprising at least one light assembly attached to said unitary steering mechanism.

14. The unitary front fork and handle bar of claim 11, further comprising a nut for securing said unitary steering mechanism to said transportation device frame.

15. A method of supporting a front portion of a transportation device, said method comprising the steps of:
securing a transportation device frame to a unitary handle bar and fork; and
joining a wheel to said unitary handle bar and fork.

16. The method of claim 15, further comprising the step of:
securing at least one rocker to said unitary handle bar and fork.

17. The method of claim 15, further comprising the step of:
securing at least one shock absorber to said unitary handle bar and fork.

18. The method of claim 15, further comprising the step of:
securing a headlight assembly to said unitary handle bar and fork.

19. The method of claim 15, wherein said step of securing a transportation device frame to a unitary handle bar and fork further comprises the step of:
securing said unitary handle bar and fork to said transportation device frame via a nut.
